(19) United States
(12) Patent Application Publication
(10) Pub. No.: US 2012/0314989 A1
(43) Pub. Date: Dec. 13, 2012

(54) OPTICAL TRANSCEIVER MODULE

(76) Inventor: HUI-TSUO CHOU, Zhubei City (TW)

(21) Appl. No.: 13/156,344

(22) Filed: Jun. 9, 2011

(51) Int. Cl. G02B 6/43

(52) U.S. Cl. 385/14

(57) ABSTRACT

An optical transceiver module includes a circuit board, at least two optical sub-assemblies, and an interface. The optical sub-assembly electrically connects with the circuit board and includes an optoelectronic component and an integrally-formed optical fiber. The interface electrically connects with the circuit board including a plurality of pins penetrating through the circuit board.

### FIELD OF THE INVENTION

The present invention relates generally to a transceiver. More specifically, the present invention relates to an optical transceiver.

### BACKGROUND OF THE INVENTION

As the amount of information communicated over networks has increased, high speed transmission has become ever more critical. As network technology grows rapidly, optoelectronic communication technology is becoming more popular because optoelectronic communication transfers a large amount of data at a high speed. One of the critical components in optoelectronic communication is the optical transceiver module, which includes a receiver transforming a received optical signal into an electronic signal. The optical transceiver module further includes a transmitter transforming an electronic signal into an optical signal and transmitting the optical signal. Many high speed data transmission networks rely on optical transceivers and similar devices for facilitating transmission and reception of digital data embodied in the form of optical signals over optical fibers.

A variety of optical transceivers are known and used to transmit and receive optical signals over optical communications networks. The known optical transceiver contains an optical fiber interface which is like a socket or a receptacle for connecting an optical fiber.

Currently, the only solution of connecting the optical transceiver with an external optical fiber is to allocate the optical fiber interface at the edge of any apparatus, thereof, no alternative can be adopted to fit different design.

Furthermore, because the type of the optical fiber interface is predetermined, the optical fiber interface is only suitable for one specific optical connector. The application of the optical transceiver is restricted.

### SUMMARY OF THE INVENTION

The object of the present invention is to provide an optical transceiver module including a circuit board, at least two optical sub-assemblies, and an interface. The optical sub-assemblies electrically connect with the circuit board and the optical sub-assembly includes an optoelectronic component and an integrally-formed optical fiber. The interface electrically connecting with the circuit board includes a plurality of pins penetrating through the circuit board.

Another object of the present invention is to provide an optical transceiver module including a circuit board, an optical sub-assembly, and an interface. The optical sub-assembly electrically connects with the circuit board and the optical sub-assembly includes an optoelectronic component and an integrally-formed optical fiber. The interface electrically connecting with the circuit board includes a plurality of pins, a first surface and a second surface opposed to the first surface. The pins can be disposed either on the first surface or the second surface.

### BRIEF DESCRIPTION OF THE DRAWINGS

FIG. 1-2 are schematic top view and a side view illustrating an optical transceiver module according to one preferred embodiment of the present disclosure.

FIG. 3-4 are schematic top view and side view illustrating an optical transceiver module according to one preferred embodiment of the present disclosure.

FIG. 5 illustrates one preferred embodiment of the present disclosure.

FIG. 6-7 are schematic top view and a side view illustrating an optical transceiver module according to one preferred embodiment of the present disclosure.

FIG. 8 illustrates one preferred embodiment of the present disclosure.

FIG. 9 illustrates one preferred embodiment of the present disclosure.

FIG. 10 illustrates one preferred embodiment of the present disclosure.

### DETAIL DESCRIPTION OF THE INVENTION

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

In order to provide more feasible ways to utilize an optical transceiver, this disclosure replaces the traditional detachable connection fashion with an integrally-formed optical fiber of an optical sub-assembly. The integrally-formed optical transceiver could be arranged without position restriction because the integrally-formed optical fiber is easy to access. The optical transceiver is also easy to connect with other apparatus without limitation because the integrally-formed optical fiber is ready and easy to extend or access.

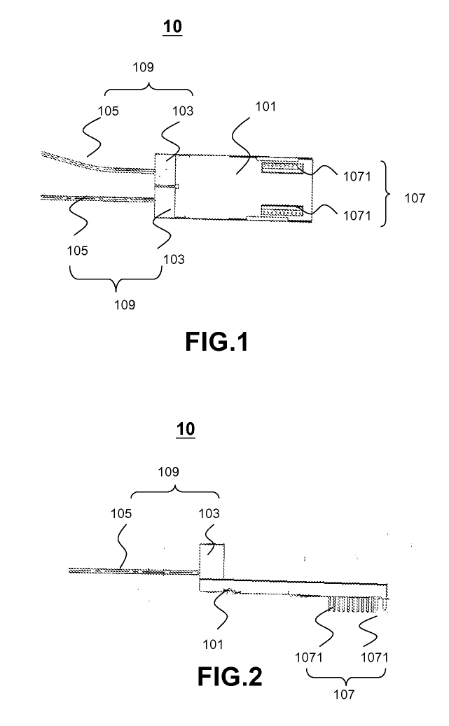

Referring to FIG. 1 and FIG. 2, one preferred embodiment of current disclosure. An optical transceiver 10 includes a circuit board 101, at least two optical sub-assemblies 109, and an interface 107.

The optical sub-assembly 109 electrically connects with the circuit board 101 and includes an optoelectronic component 103 and an integrally-formed optical fiber 105. The optoelectronic component 103 receives an optical signal from the integrally-formed optical fiber 105 and converts the optical signal to an electrical signal. Moreover, the optoelectronic component 103 further transmits the electrical signal to the circuit board 101. The optoelectronic component 103 can be also configured to receive an electrical signal from the circuit board 101 and converts the electrical signal to an optical signal, thereafter the optoelectronic component 103 further transmits the optical signal to the integrally-formed optical fiber 105.

The interface 107 includes a plurality of pins 1071 which are penetrating through the circuit board 101, with which the interface 107 electrically connects. Optionally, the optical transceiver 10 electrically connects to the other device or apparatus (not shown) via the interface 107.

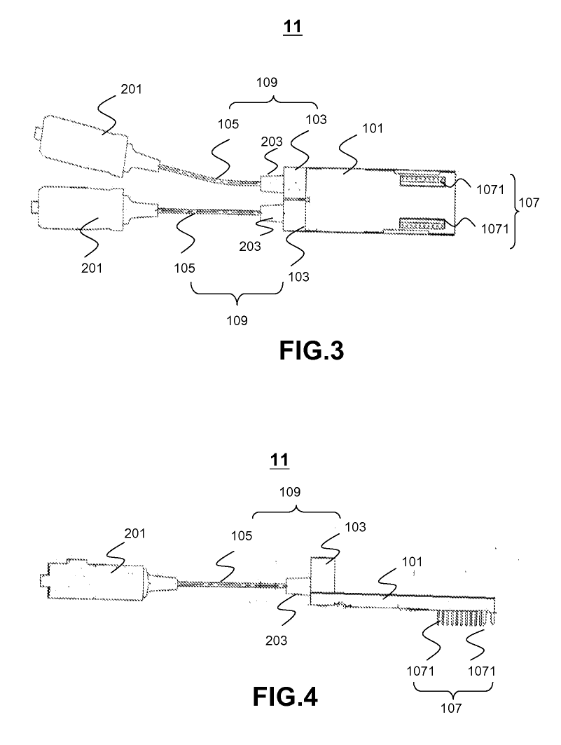

Referring to FIG. 3 and FIG. 4, one preferred embodiment of current disclosure. An optical transceiver 11 includes a circuit board 101, at least two optical sub-assemblies 109, an interface 107, an optical fiber connector 201 and a protection device 203. The optical sub-assembly 109 electrically connects with the circuit board 101 and includes an optoelectronic component 103 and an integrally-formed optical fiber 105.

The optoelectronic component 103 receives an optical signal from the integrally-formed optical fiber 105 and converts the optical signal to an electrical signal. Moreover, the optoelectronic component 103 further transmits the electrical signal to the circuit board 101. The optoelectronic component 103 can be also configured to receive an electrical signal from the circuit board 101 and converts the electrical signal to an optical signal, thereafter the optoelectronic component 103 further transmits the optical signal to the integrally-formed optical fiber 105.

The interface 107 includes a plurality of pins 1071 which are penetrating through the circuit board 101, with which the interface 107 electrically connects. Optionally, the optical transceiver 10 electrically connects to the other device or apparatus (not shown) via the interface 107.

The optical fiber connector 201 connects one end of the integrally-formed optical fiber 105. Optionally, the optical transceiver 11 connects to the other device, apparatus or an optical fiber(not shown) via the optical fiber connector 201. The protection device 203 is disposed on the junction position which is between the integrally-formed optical fiber 105 and the optoelectronic component 103. The protection device 203 encloses the junction position in order to protect the connection between the integrally-formed optical fiber 105 and the optoelectronic component 103 from breaking.

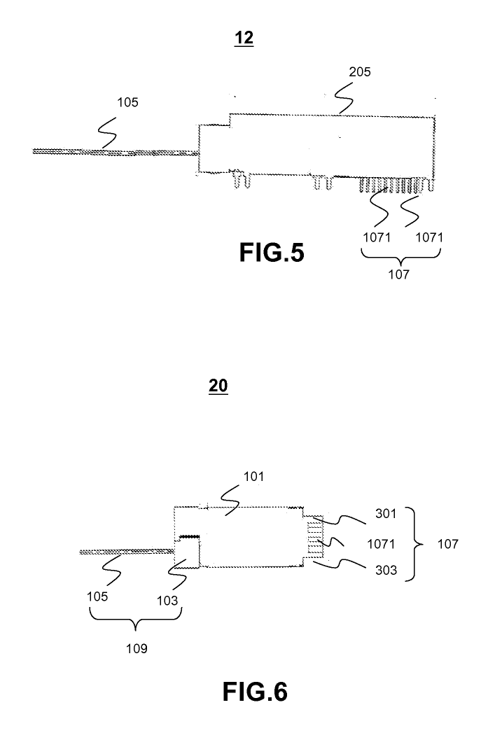

Referring to FIG. 5, one preferred embodiment of current disclosure. An optical transceiver 12 includes a case 205. The case 205 encloses a circuit board inside the case 205, and leaves the interface 107 and the integrally-formed optical fiber 105 outside.

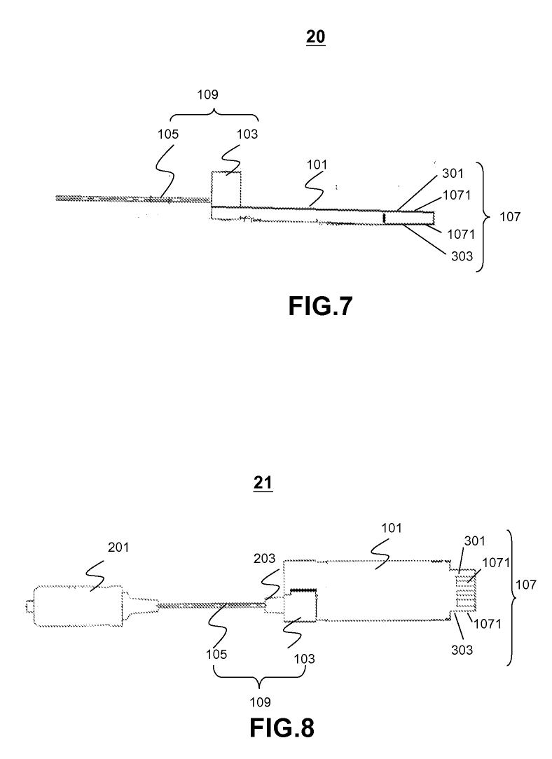

Referring to FIG. 6 and FIG. 7, one preferred embodiment of current disclosure. An optical transceiver 20 includes a circuit board 101, an optical sub-assembly 109 and an interface 107.

The optical sub-assembly 109 electrically connects with the circuit board 101 and includes an optoelectronic component 103 and an integrally-formed optical fiber 105. The optoelectronic component 103 receives an optical signal from the integrally-formed optical fiber 105 and converts the optical signal to an electrical signal. Moreover, the optoelectronic component 103 further transmits the electrical signal to the circuit board 101. The optoelectronic component 103 can be also configured to receive an electrical signal from the circuit board 101 and converts the electrical signal to an optical signal, thereafter the optoelectronic component 103 further transmits the optical signal to the integrally-formed optical fiber 105.

The interface 107 electrically connects with the circuit board 101, the interface 107 includes a plurality of pins 1071, a first surface 301, a second surface 303 which is opposite to the first surface 301, and the pins 1071 which are disposed either on the first surface 301 or the second surface 303. The pins also could be disposed on the first surface 301 and the second surface 303 at the same time. The interface 107 electrically connects with the circuit board 101. Optionally, the optical transceiver 20 electrically connects to the other device or apparatus (not shown) via the interface 107. The interface 107 is a gold finger interface or an edge connector interface, such that the optical transceiver 20 can plug in other device or apparatus via the interface 107. The edge connector interface is the portion of a circuit board consisting of traces leading to the edge of the circuit board that are intended to plug into a matching socket and the gold finger interface is one kind of connector with conductible pads arranging like fingers.

Referring to FIG. 8, one preferred embodiment of current disclosure. An optical transceiver 21 includes a circuit board 101, optical sub-assembly 109, an interface 107, an optical fiber connector 201 and a protection device 203.

The optical sub-assembly 109 electrically connects with the circuit board 101 and includes an optoelectronic component 103 and an integrally-formed optical fiber 105. The optoelectronic component 103 receives an optical signal from the integrally-formed optical fiber 105 and converts the optical signal to an electrical signal. Moreover, the optoelectronic component 103 further transmits the electrical signal to the circuit board 101. The optoelectronic component 103 can be also configured to receive an electrical signal from the circuit board 101 and converts the electrical signal to an optical signal, thereafter the optoelectronic component 103 further transmits the optical signal to the integrally-formed optical fiber 105.

The interface 107 electrically connects with the circuit board 101 and the interface 107 electrically connects to the other device or apparatus (not shown) via the interface 107. The interface 107 includes a plurality of pins 1071, a first surface 301 and a second surface 303 which is opposite the first surface 301, and the pins 1071 are disposed on the first surface 301 or the second surface 303. The pins 1071 also could be disposed on both the first surface 301 and the second surface 303, hereby the interface 107 electrically connects with the circuit board 101. Optionally, the optical transceiver 21 electrically can connect to the other device or apparatus (not shown) via the interface 107. The interface 107 is a gold finger interface or an edge connector interface. The connection type between the interface 107 and the other device or apparatus (not shown) is pluggable. The optical fiber connector 201 connects one end of the integrally-formed optical fiber 105. The optical transceiver 21 connects to the other device, apparatus or even an optical fiber (not shown) via the optical fiber connector 201. The protection device 203 is disposed on the junction position which is between the integrally-formed optical fiber 105 and the optoelectronic component 103. The protection device 203 encloses the junction position to protect the connection between the integrally-formed optical fiber 105 and the optoelectronic component 103 from breaking.

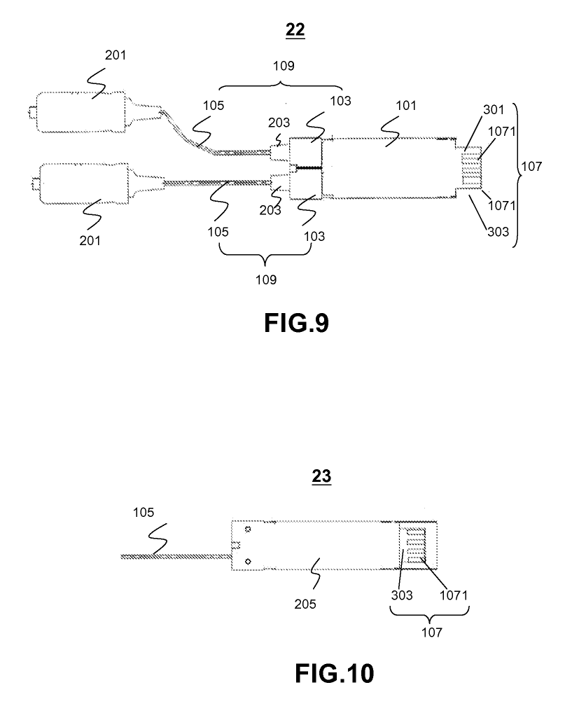

Referring to FIG. 9, one preferred embodiment of current disclosure. An optical transceiver 22 includes a plurality of optical sub-assembly 109 more than the optical transceiver 21 as the above description.

Referring to FIG. 10, one preferred embodiment of current disclosure. An optical transceiver 23 includes a case. The case encloses a circuit board inside, and remains the interface 107 and the integrally-formed optical fiber 105 outside the case.

While the disclosure has been described in terms of what is presently consider to be the preferred embodiments, it is to be understood that the disclosure needs not be limited to the disclosed embodiment. On the contrary, it is intended cover various modifications and similar arrangements included within the spirit and scope of the appended claims which are to be accorded with the broadest interpretation so as to encompass all such modification and similar structures.

What is claimed is:

1. An optical transceiver module comprising:
a circuit board;
at least two optical sub-assemblies, wherein the optical sub-assembly comprises an optoelectronic component and an integrally-formed optical fiber, and the optical sub-assembly electrically connects with the circuit board; and
an interface electrically connecting with the circuit board, wherein the interface comprises a plurality of pins penetrating through the circuit board.

2. The optical transceiver module as recited in claim 1 further comprising an optical fiber connector, wherein the optical fiber connector connects to one end of the integrally-formed optical fiber.

3. The optical transceiver module as recited in claim 1 further comprising a protection device, wherein the protection device is disposed on the junction position which is between the integrally-formed optical fiber and the optical sub-assembly.

4. The optical transceiver module as recited in claim 1 further comprising a case, wherein the case encloses the circuit board.

5. An optical transceiver module comprising:
a circuit board;
an optical sub-assembly, wherein the optical sub-assembly comprises an optoelectronic component and an integrally-formed optical fiber, and the optical sub-assembly electrically connects with the circuit board; and
an interface electrically connecting with the circuit board, wherein the interface comprises a plurality of pins, a first surface and a second surface opposed to the first surface, and the pins are disposed on the first surface or the second surface.

6. The optical transceiver module as recited in claim 5 wherein the pins are disposed on the first surface and the second surface.

7. The optical transceiver module as recited in claim 5 further comprising an optical fiber connector, wherein the optical fiber connector connects one end of the integrally-formed optical fiber.

8. The optical transceiver module as recited in claim 5 further comprising a protection device, wherein the protection device is disposed on the junction position which is between the integrally-formed optical fiber and the optical sub-assembly.

9. The optical transceiver module as recited in claim 5 further comprising a case, wherein the case encloses the circuit board.
